(19) United States
(12) Patent Application Publication
(10) Pub. No.: US 2025/0342326 A1
(43) Pub. Date: Nov. 6, 2025

(54) TRUST THROUGH TRANSPARENCY: EXPLAINABLE SOCIAL NAVIGATION FOR AUTONOMOUS MOBILE ROBOTS VIA VISION-LANGUAGE MODELS

(71) Applicant: New York University, New York, NY (US)

(72) Inventors: Aliasghar Arab, New York, NY (US); Kiruthiga Chandra Shekar, Brooklyn, NY (US); Chinmay Prashanth, Brooklyn, NY (US); Pranav Doma, Rego Park, NY (US); Vikram Subramaniam, Brooklyn, NY (US); Katsuo Kurabayashi, Harrison, NY (US); Oluwadamilola Sotomi, Brooklyn, NY (US); Devika Kodi, Brooklyn, NY (US)

(21) Appl. No.: 19/199,877

(22) Filed: May 6, 2025

Related U.S. Application Data
(60) Provisional application No. 63/643,327, filed on May 6, 2024.

(51) Int. Cl. G06F 40/58

(52) U.S. Cl. CPC G06F 40/58

(57) ABSTRACT

A multimodal explainability module that integrates vision language models and heatmaps to improve transparency during navigation is described. The system enables robots to perceive, analyze, and articulate their observations through natural language summaries.

### § 1. RELATED APPLICATION(S)

The present application claims priority to U.S. Provisional Application Ser. No. 63/643,327 (referred to as “the '327 provisional” and incorporated herein by reference), titled “Systems and Methods for Human-Centric Mobile Robotics Interface and Motion Enabled by Socially Aware Learning”, filed on May 6, 2024, and listing Aliasghar Arab, Kiruthiga Chandra Shekar, Chinmay Prashanth, Pranav Doma, Vikram Subramaniam, and Katsuo Kurabayashi as the inventors. The present application is not limited by any specific requirements discussed in the '327 provisional.

### § 2. BACKGROUND OF THE INVENTION

### § 2.1 Field of the Invention

The present invention concerns autonomous robots. In particular, the present invention concerns interactions, such as interactions that might cause a social conflict, between autonomous robots and one or more humans.

### § 2.2 Background Information

As Autonomous Mobile Robots (AMRs) become increasingly integrated into social and service environments, ensuring safe and efficient navigation while interacting with humans remains a significant challenge. (See, e.g., the document, Jimmy Baraglia, Maya Cakmak, Yukie Nagai, Rajesh P N Rao, and Minoru Asada. Efficient human-robot collaboration: when should a robot take initiative? The International Journal of Robotics Research, 36(5-7):563-579, 2017 (Incorporated herein by reference.).) Traditional AMRs often struggle to communicate their decision-making processes, leading to a lack of trust and usability in human-robot collaboration. (See, e.g., the document, Kiruthiga C Shekar, Pranav Doma, Chinmay Prashanth, Vikram Subramaniam, and Aliasghar Arab. Explainable autonomous mobile robots: Interface and socially aware learning. Authorea Preprints, 2024 (Incorporated herein by reference.).) An important aspect of Human Robot Interaction (HRI) is explainability. It is important that robots not only make decisions, but also communicate their reasoning in an intuitive manner to improve predictability and user confidence. Transparency in robotic decision making fosters trust by helping users anticipate robot behavior and interact naturally. (See, e.g., the document, John D Lee and Katrina A See. Trust in automation: Designing for appropriate reliance. Human factors, 46(1):50-80, 2004 (Incorporated herein by reference.).) Without it, humans struggle to adapt, leading to inefficiencies and hesitation. Although existing research has explored socially aware navigation models and explainable AI (XAI) in robotics, many approaches remain limited to internal decision logic, lacking human-readable real-time explanations. (See, e.g., the document, Guy Laban, Arvid Kappas, Val Morrison, and Emily S Cross. Opening up to social robots: how emotions drive self-disclosure behavior. In 2023 32nd IEEE International Conference on Robot and Human Interactive Communication (RO-MAN), pages 1697-1704. IEEE, 2023 (Incorporated herein by reference.).) Furthermore, current systems often fail to incorporate multimodal reasoning, such as combining visual perception with language-based justifications. (See, e.g., the document, Lindsay Sanneman and Julie A Shah. The situation awareness framework for explainable ai (safe-ai) and human factors considerations for xai systems. International Journal of Human-Computer Interaction, 38(18-20):1772-1788, 2022 (Incorporated herein by reference.).)

XAI plays an important role in improving human trust in autonomous systems. Early approaches used language models and prompt engineering for robot justifications, but lacked visual context, making explanations less intuitive. Recent studies incorporate Vision-Language Models (VLMs) to generate context-aware explanations by using cameras onboard. (See, e.g., the document, David Sobr'in-Hidalgo, Miguel Angel Gonzalez-Santamarta, Angel Manuel Guerrero-Higueras, Francisco Javier Rodriguez-Lera, and Vicente Matellan-Olivera. Enhancing robot explanation capabilities through vision-language models: a preliminary study by interpreting visual inputs for improved human-robot interaction. arXiv preprint arXiv:2404.09705, 2024 (Incorporated herein by reference.).) Explainability has also been explored in robot fault recovery, where natural language justifications assist users in diagnosing errors. (See, e.g., the document, Devleena Das, Siddhartha Banerjee, and Sonia Chernova. Explainable ai for robot failures: Generating explanations that improve user assistance in fault recovery. In Proceedings of the 2021 ACM/IEEE international conference on human-robot interaction, pages 351-360, 2021 (Incorporated herein by reference.).) Surrogate models, such as those based on Shapley values, improve decision transparency. (See, e.g., the document, Konstantinos Gavriilidis, Andrea Munafo, Wei Pang, and Helen Hastie. A surrogate model framework for explainable autonomous behavior. arXiv preprint arXiv:2305.19724, 2023 (Incorporated herein by reference.).) In addition, reinforcement learning (RL) approaches have used causal justifications based on Markov Decision Process (MDP) to improve policy interpretability. (See, e.g., the document, Mira Finkelstein, Lucy Liu, Yoav Kolumbus, David C Parkes, Jeffrey S Rosenschein, Sarah Keren, et al. Explainable reinforcement learning via model transforms. Advances in Neural Information Processing Systems, 35:34039-34051, 2022 (Incorporated herein by reference.).) These approaches highlight the importance of interpretable AI in improving human trust and usability in robotics. The documents: Jaibir Singh, Suman Rani, and Garaga Srilakshmi. Towards explainable ai: Interpretable models for complex decision-making. In 2024 International Conference on Knowledge Engineering and Communication Systems (ICKECS), volume 1, pages 1-5. IEEE, 2024 (Incorporated herein by reference.); and Francisco Cruz, Charlotte Young, Richard Dazeley, and Peter Vamplew. Evaluating human-like explanations for robot actions in reinforcement learning scenarios. In 2022 IEEE/RSJ International Conference on Intelligent Robots and Systems (IROS), pages 894-901. IEEE, 2022 (Incorporated herein by reference.).) further evaluate how explanations in reinforcement learning scenarios align with human expectations, emphasizing the need for human-like justifications in real-world HRI settings. Parallelly, recent systems explore the use of vision-language models to improve HRI by allowing robots to understand and respond through more natural multimodal communication. (See, e.g., the document, Ammar N Abbas and Csaba Beleznai. Talkwithmachines: Enhancing human-robot interaction through large/vision language models. In 2024 Eighth IEEE International Conference on Robotic Computing (IRC), pages 253-258. IEEE, 2024 (Incorporated herein by reference.).)

Social navigation requires robots to follow human norms. Traditional models like the Social Force Model (SFM) simulate human navigation but lack adaptability. Learning from Demonstration (LfD) has enabled robots to replicate human behaviors, though without high-level reasoning, leading to brittle responses. Recent efforts integrate language-based reasoning, encouraging datasets for perception, planning, and social navigation. (See, e.g., the document, Amirreza Payandeh, Daeun Song, Mohammad Nazeri, Jing Liang, Praneel Mukherjee, Amir Hossain Raj, Yangzhe Kong, Dinesh Manocha, and Xuesu Xiao. Social-llava: Enhancing robot navigation through human-language reasoning in social spaces. arXiv preprint arXiv:2501.09024, 2024 (Incorporated herein by reference.).) Risk-aware motion planning with multi-modal perception enhances safety in crowded environments. One method integrates Teb (Timed Elastic Band) with ORCA (Optimal Reciprocal Collision Avoidance) to refine real-time obstacle avoidance. (See, e.g., the document, Zhiwei Wang, Peiqing Li, Qipeng Li, Zhongshan Wang, and Zhuoran Li. Motion planning method for car-like autonomous mobile robots in dynamic obstacle environments. IEEE Access, 11:137387-137400, 2023 (Incorporated herein by reference.).) Local path optimization using DWA and TEB planners in the Robot Operating System (ROS) improves narrow passage navigation and social compliance. (See, e.g., the document, Huajun Yuan, Hanlin Li, Yuhan Zhang, Shuang Du, Limin Yu, and Xinheng Wang. Comparison and improvement of local planners on ros for narrow passages. In 2022 International Conference on High Performance Big Data and Intelligent Systems (HDIS), pages 125-130. IEEE, 2022 (Incorporated herein by reference.).) However, beyond motion planning, robots should also integrate social reasoning for human-aware navigation. Recent work integrates vision-language models with robot navigation, enabling socially aware behavior by scoring navigation decisions based on social norms and visual context. (See, e.g., the document, Daeun Song, Jing Liang, Amirreza Payandeh, Amir Hossain Raj, Xuesu Xiao, and Dinesh Manocha. Vlm-social-nav: Socially aware robot navigation through scoring using vision-language models. IEEE Robotics and Automation Letters, 2024 (Incorporated herein by reference.).)

VLMs advance perception by enhancing situational awareness through text and visual data processing. Grad-CAM aids in interpretability by highlighting the salient image regions that influence robot decisions. (See, e.g., the document, Ramprasaath R Selvaraju, Michael Cogswell, Abhishek Das, Ramakrishna Vedantam, Devi Parikh, and Dhruv Batra. Grad-cam: visual explanations from deep networks via gradient-based localization. International journal of computer vision, 128:336-359, 2020 (Incorporated herein by reference.).) This improves trustworthiness in robotic applications by providing visual justifications. VLMs have also been explored for zero-shot semantic navigation, where they map visual input to frontier spaces for high-level planning without requiring task-specific training, as demonstrated in VLFM. (See, e.g., the document, Naoki Yokoyama, Sehoon Ha, Dhruv Batra, Jiuguang Wang, and Bernadette Bucher. Vlfm: Vision-language frontier maps for zeroshot semantic navigation. In 2024 IEEE International Conference on Robotics and Automation (ICRA), pages 42-48. IEEE, 2024 (Incorporated herein by reference.).) Beyond processing visual data, VLMs improve contextual understanding. BLIP (Bootstrapping Language-Image Pretraining) strengthens image-text grounding, allowing robots to generate context-aware descriptions. (See, e.g., the document, Junnan Li, Dongxu Li, Caiming Xiong, and Steven Hoi. Blip: Bootstrapping language-image pre-training for unified vision-language understanding and generation. In International conference on machine learning, pages 12888-12900. PMLR, 2022 (Incorporated herein by reference.).) This improves HRI, instruction following, and autonomous decision-making. Ensuring safe and explainable navigation remains a challenge. An AI-based assurance framework integrates XAI and security monitoring for real-time anomaly detection, enhancing safety and explainability in AI-driven autonomous systems. (See, e.g., the document, Denzel Hamilton, Kevin Kornegay, and Lanier Watkins. Autonomous navigation assurance with explainable ai and security monitoring. In 2020 IEEE Applied Imagery Pattern Recognition Workshop (AIPR), pages 1-7. IEEE, 2020 (Incorporated herein by reference.).)

### § 3. SUMMARY OF THE INVENTION

To address the foregoing limitations, the present inventors introduce a multimodal explainability module that enables an AMR to generate human perceptible and interpretable, real-time explanations for its navigation behavior. This new approach leverages Vision-Language Foundation Models (VLFMs), integrating camera-based perception, heatmaps, and language models to articulate decisions. The cornerstone of our exploration lies in recognizing context-aware behavior and the explainability of AMRs around people to improve social acceptance. As new members of society, robots should take initiatives to be accepted by existing communities for future efficient contributions. The technological and social challenges of partially unknown interactions between robots and individuals have been studied, highlighting the disparities in the operational patterns that shape the robot environment. The example robot provides contextual explanations in natural language alongside heatmap-based visual reasoning, ensuring greater transparency in interactions.

The present application extends the inventors' framework to AMRs by presenting more extensive experimental results and incorporating user surveys. (See, e.g., the document, Aliasghar Arab, Ilija Hadzic, and Jingang Yi. Safe predictive control of four-wheel mobile robot with independent steering and drive. In 2021 American Control Conference (ACC), pages 2962-2967. IEEE, 2021 (Incorporated herein by reference.).) The present inventors develop a ROS2-based explainability module that integrates a camera node, visual captioning using BLIP, Grad-CAM heatmaps for visual interpretability, and LLM-based natural language generation for real-time explanations. The interpretability of the framework is evaluated by measuring the accuracy of the explanation and alignment with human expectations through quantitative metrics.

An example method for generating an (e.g., human perceivable and understandable) explanation of an AMR action is provided. The example method receives at least one image from a camera stream associated with the AMR. The example method then generates a visual saliency heatmap using the at least one image and the AMR action. Next, the example method determines whether or not the AMR action will cause a potential social conflict with at least one human. Responsive to determining that the AMR action will cause a potential social conflict with at least one human, the example method generates an explanation of the AMR action and causes the AMR to render the explanation for perception by the at least one human. Responsive to a determining that the AMR action will not cause a potential social conflict with at least one human, the example method continues to receive and process images.

In at least some example implementations of the method, the explanation includes the visual saliency heatmap. In at least some example implementations of the method, the method extracts features from the at least one image received, and generates a natural language explanation from at least one of (i) the features extracted, and/or (ii) the visual saliency heatmap, wherein the explanation includes both (i) the visual saliency heatmap and (ii) the natural language explanation. In some such implementations, the natural language explanation is generated from at least one of (i) the features extracted, and/or (ii) the visual saliency heatmap, by (1) generating from the features extracted, a caption using a vision language model (VLM), and (2) generating the natural language explanation from the caption and the visual saliency heatmap.

In at least some such implementations, the act of rendering the explanation for perception by at least one human includes displaying both (1) the visual saliency heatmap and (2) the natural language explanation. In at least some other such implementations, the act of rendering the explanation for perception by at least one human includes (1) displaying the visual saliency heatmap, (2) synthesizing speech from the natural language explanation, and (3) outputting, via a speaker, the speech synthesized. The caption may be a contextual caption describing the AMR action in the context of the at least one image. As discussed in more detail below, the caption may be generated using Bootstrapped Language Image Pretraining (BLIP). In some example implementations, the visual saliency heatmap is generated using a Gradient-weighted Class Activation Mapping with a Residual Network neural network model to highlight image areas that contributed most to the AMR action. (For example, areas that contributed most the AMR action might be colored red, while areas that did not contribute to the AMR action might be colored blue (or uncolored), and areas that somewhat contributed to the AMR action might be colored within this spectrum, with the color depending on how much they contributed.) In some example implementations, the act of generating a natural language expression is performed by a large language model (LLM) external to the AMR.

In at least some example implementations of the example method, the act of determining whether or not a potential social conflict exists includes determining whether or not the AMR action is more probable than a predetermined threshold to cause human discomfort. The threshold may be changed so that it is a function of the urgency of the AMR action. In some example implementations, the potential social conflict is one or more of (A) a potential discomfort caused to the at least one human by the AMR action, (B) a potential discomfort caused to the at least one human by an alternative to the AMR action, (C) determining that at least one human will be within a predetermined distance of a planned path of the AMR, (D) determining that at least one human will be within a predetermined distance of a planned path of the AMR and have a line of sight of the AMR in the planned path, (E) determining that at least one human will be able to hear the AMR as it navigates a planned path, and/or (F) determining that at least one human will have an activity interrupted by a planned path of the AMR. Note that a “social conflict” may depend on cultural norms, which may be implied by location information of the AMR (or other information gathered by, or provided to, the AMR).

In some example implementations, the explanation of the AMR action is a proposed path of the AMR, and the act of rendering the explanation for perception by at least one human includes projecting the proposed path of the AMR.

In some example implementations, a utility of the explanation is a function of both (1) a latency needed to generate the explanation, and (2) content of the explanation. In such example implementations, the act of generating the explanation of the AMR action includes increasing or maximizing the utility of the explanation.

Example systems for performing any of the foregoing methods are also described.

A non-transitory computer-readable storage medium may be provided for storing processor-executable instructions which, when executed by at least one processor, cause the at least one processor to perform any of the methods described.

### § 4. BRIEF DESCRIPTION OF THE DRAWINGS

FIG. 1 illustrates an example AMR on which an example explanation generation module may be implemented.

FIG. 2 is a flow diagram of an example method for generating an (e.g., human perceivable and understandable) explanation of an AMR action.

FIG. 3 illustrates an example AMR provided with an example explanation generation module/node, and an example of the operations of its components.

FIG. 4 is a block diagram of an exemplary machine that may perform one or more of the processes described, and/or store information used and/or generated by such processes.

FIG. 5 illustrates an example of a guiding prompt used to ensure that the explanation follows a consistent and understandable format.

FIG. 6 is a table that provides a comparison of navigation performance under two conditions: without explainability; and with explainability.

FIG. 7 is a table of survey results measuring user trust.

FIG. 8 is a bar chart of user survey results under a first test.

FIG. 9 is a bar chart of user survey results under a second test.

FIG. 10 is a confusion matrix showing performance of the explainability module for true positive, false positive, false negative, and true negative.

### § 5. DETAILED DESCRIPTION

The present disclosure may involve novel methods, apparatus, message formats, and/or data structures for helping to explain autonomous robot action(s) to one or more humans that might have a social conflict caused by an action of the autonomous robot. The following description is presented to enable one skilled in the art to make and use the described embodiments, and is provided in the context of particular applications and their requirements. Thus, the following description of example embodiments provides illustration and description, but is not intended to be exhaustive or to limit the present disclosure to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present description unless explicitly described as such. Also, as used herein, the article “a” is intended to include one or more items. Where only one item is intended, the term “one” or similar language is used. Thus, the present disclosure is not intended to be limited to the embodiments shown and the inventors regard their invention as any patentable subject matter described.

### § 5.1 DEFINITIONS

“Social Conflict” means that an action of an autonomous mobile robot (AMR) will cause some type of conflict, or annoyance, or discomfort by a human affected by the action. As one example, a social conflict might occur when at least one human will be within a predetermined distance of a planned path of the AMR. As another example, a social conflict might occur when at least one human will be within a predetermined distance of a planned path of the AMR and have a line of sight of the AMR in the planned path. As yet another example, a social conflict might occur when at least one human will be able to hear the AMR as it navigates a planned path. As yet still another example, a social conflict might occur when at least one human will have an activity (e.g., walking, talking with another human, working, conferring with another human, etc.) interrupted by a planned path of the AMR. As yet another example, a social conflict might occur when at least one human will have an expectation of privacy violated by the action of the AMR. This is a non-exhaustive list of examples of social conflicts. Note that social conflicts might differ in different contexts, for example, within different cultures. Therefore, what is considered to be a social conflict might depend on the geographic location of the AMR.

A “node” or “module” may include hardware and/or software.

### § 5.2 EXAMPLE PROBLEM FORMULATION

Autonomous mobile robotic systems operating in human-centered environments should (and some cases must) adhere to predefined social norms to ensure safe and socially acceptable interactions by avoiding unnecessary navigation conflicts through explainability. One way to define the explainable mobile robot navigation task is as a tuple:

$${τ}_{nav} = ( S , G , P , E , ε ) \qquad ( 1 )$$

where, S=(q, v, qₕᵤₘₐₙ) is the state of the robot, with q∈ [symbol] ⁿ as the position and orientation of the robot, v∈ [symbol] ⁿ as the velocity of the robot, qₕᵤₘₐₙ^{j}∈ [symbol] ⁿ as the observed position and orientation of the human j^{th} from the robot's point of view. G≡q_{g}∈ [symbol] ⁿ is the target configuration in the robot workspace. P=π:[0, T]→ [symbol] ⁿ is the planned trajectory that maps time to robot location and velocities, so that the robot safely transitions from the initial state q₀ to q_{g} while avoiding obstacles and social conflicts with humans. E={eₜ|t∈[0, T]} is the set of (e.g., multimodal) explanations generated during execution, where each eₜ includes interpretable outputs, such as descriptions of natural language through combination of visual heatmaps, conditioned on the robot's observations and decisions at time t. ε∈[0, 1] is the explainability score reflecting the degree to which the system's behavior is interpretable to human observers, as measured via user feedback or agreement metrics (e.g., confusion matrix alignment with human expectations).

The set of social constraints, human-centric safety requirements, and interaction rules can be formalized as a set of norm constraints Ωₙₒᵣₘ, which should (and in some cases must) be satisfied at all times.

$${Ω}_{norm} = {⋂}_{i ϵ M} {Ω}_{i} \qquad ( 2 )$$

where Ωᵢ represents the constraints imposed by the social norm i from the set of governing rules M. For this purpose, the present inventors model these constraints in three different categories as suggested in the document, Aliasghar Arab, Ilija Hadzic', and Jingang Yi. Safe predictive control of four-wheel mobile robot with independent steering and drive. In 2021 American Control Conference (ACC), pages 2962-2967. IEEE, 2021 (Incorporated herein by reference.).) These three categories are (1) human safety and social norms, (2) socially acceptable motion, and (3) social navigation constraints. Each of these three categories is explained in more detail below.

Per the human safety and social norms constraint category, the robot should (and in some cases must) maintain a safe distance from humans and adapt its trajectory to avoid discomfort as Ω₁.

$${d}_{human} \geq max \{ {d}_{social} , {d}_{safe} \} , \qquad ( 3 )$$

where, dₕᵤₘₐₙ is distance from the robot to human and d_{social} and d_{safe} are the safe and socially acceptable distance constants, respectively. Per the socially acceptable motion constraint category, the robot should avoid abrupt stops, excessive speed variations, or intrusive behaviors that could cause discomfort in human interactions, unless an aggressive maneuver is necessary to avoid an accident as Ω₂.

$$\vert \dot{v} \vert \leq \{ \begin{matrix}No constraint & if {d}_{human} \geq {d}_{social} \\ {α}_{social} & if {d}_{social} \geq {d}_{human} \geq {d}_{safe} \\ No constraint & if {d}_{human} < {d}_{safe}\end{matrix} \qquad ( 4 )$$

where, q=[x, y, ψ] represent the robot pose in the odometry frame and v=[vₓ, v_{y}, ψ′] denote its velocity in the local frame. α_{social} is the maximum acceleration accepted in a social scenario for the robot. Finally, per the social navigation constraints constraint category, the robot should respect human space and avoid disrupting groups or ongoing interactions

$$h ( P , {q}_{human}^{j} ) \geq 0 , ∀ {q}_{human}^{j} ∈ {ℳ}_{social} i . \qquad ( 5 )$$

where, [symbol] _{social} is the set of socially relevant human configurations (e.g., people conversing) and h(⋅)≥0 encodes a social compliance or safety constraint. Any social conflict or non-safe situation should be represented by h(P,

$${q}_{human}^{j} ) \leq 0$$

to ensure that no conflict occurs by satisfying Eq. (5). By integrating socially aware constraints into navigation parameters, the proposed framework ensures that robot behavior remains predictable, interpretable, and aligned with human expectations, thus enhancing explainability and thus acceptability HRI.

### § 5.3 EXAMPLE AMR ENVIRONMENT

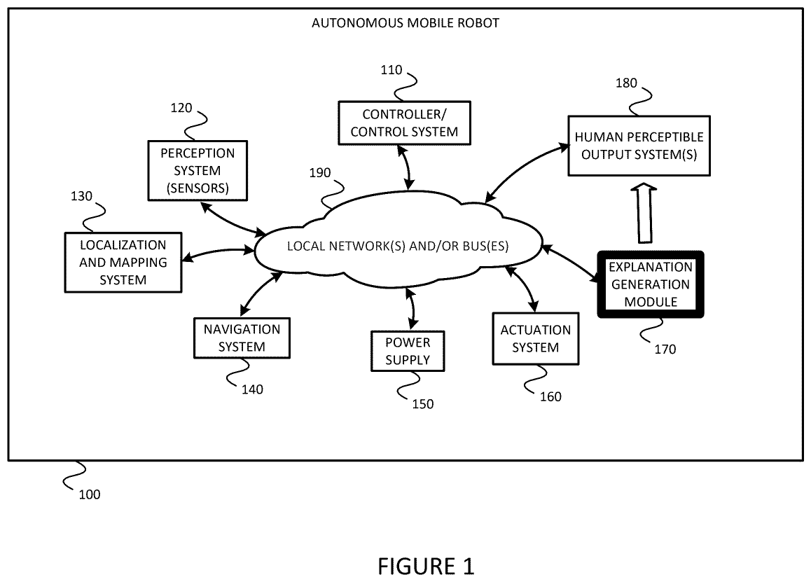

FIG. 1 illustrates an example AMR 100 on which an example explanation generation module 170 may be implemented. The example AMR 100 may include, for example, a controller/control system 110, a perception system (e.g., sensor(s)) 120, a localization and mapping system 130, a navigation system 140, a power supply 150, an actuation system 160, an example explanation generation module 170 consistent with the present application, and a human-perceptible output system(s) 180. The various components may exchange control information/signals, a data via a local network and/or one or more buses 190.

The controller/control system 110 manages the AMR's hardware and interprets commands. This 110 may include one or more of motor controllers (e.g., drive wheels, propellers, actuators, etc.). This 110 may also include microcontrollers (e.g., Arduino, STM32) that handle real-time processing for control tasks. This 110 may also include controllers to provide smooth and stable movement. This 110 may also include computation and processing units for handling high-level decisions and processing, such as, for example, an onboard computer (e.g., NVIDIA Jetson, Raspberry Pi, Intel NUC) that runs ROS, AI algorithms, and/or sensor processing, and/or embedded systems that handle low-latency control and basic logic. This 110 may also include one or more of a ROS (Robot Operating System, which is common middleware for AMR development), and/or a machine learning/AI module(s) for advanced perception, prediction, and decision-making. Note that some of the control system 110 may be performed remotely, external to the AMR. A communications module (not shown) permits wired and/or wireless communication with an external control system(s) and/or other external systems.

The perception system (e.g., sensor(s)) 120 allow the AMR to perceive its environment. This 120 may include one or more of LiDAR (Light Detection and Ranging) for mapping, obstacle detection, and localization, camera(s) for object recognition, visual navigation, and/or situational awareness, ultrasonic/infrared sensors for short-range obstacle avoidance, an IMU (Inertial Measurement Unit) for tracking orientation and acceleration, encoders for monitoring wheel rotation to estimate movement and speed, etc. In one example implementation, the perception system includes at least a video camera for capturing image frames.

The localization and mapping system 130 allows the AMR to be aware of its position in space. It 130 may include one or more of SLAM (Simultaneous Localization and Mapping) for building and updating a map while tracking the AMR's position within it, GPS for providing global positioning when available, and/or sensor fusion modules for combining data from multiple sources (e.g., RF emitters) for accurate localization.

The navigation system 140 is responsible for planning the movement of the AMR. It 140 may include one or more of path planning algorithms for computing (e.g., optimal) routes, obstacle avoidance for adjusting the AMR's path in real time (e.g., using sensor input), and/or motion control for converting navigation instructions into motor commands.

The power supply 150 may include one or more of a battery pack (e.g., Li-ion or Li—Po batteries), and/or a power management system for regulating and distributing power to various components of the AMR safely.

The actuation system 160 may include one or more of motors, wheels, tracks, propellers, etc., for physically moving the AMR and/or manipulating its environment (e.g., using arms/grippers for picking and interacting with objects).

The example explanation generation module 170 consistent with the present application is used to generate a human-perceptible explanation of a current or near future action of the AMR, especially if that AMR action will, or likely will, cause a social conflict with one or more humans. This explanation is provided to one or more humans via a human-perceptible output system(s) 180. This 180 may include one or more of a display, a projector, and/or one or more speakers, etc.

The local network and/or one or more buses 190 may include, for example, a shared buses, an Ethernet network, etc. It 190 allows the various components of the AMR to communicate with each other, as needed.

### § 5.4 EXAMPLE EXPLAINABILITY METHODOLOGY AND ARCHITECTURE

### § 5.4.1 Example Methodology

One objective consistent with the present description is to calculate a safe, feasible and interpretable path P, while increasing (e.g., maximizing) ε through novel explainability modules, to improve transparency and trust during robot navigation in dynamic environments populated by humans. One example approach includes three parts, namely:
1. Development of a multimodal explainability system;
2. Deployment in an AMRs for real-time validation; and
3. Integration with an autonomous navigation stack.

In this description, it is assumed that the effectiveness of the explainability module is quantified by a scalar explainability factor ε∈[0, 1], which reflects how well the robot's behavior is understood by users. The value of ε is determined through user feedback collected after the experiment via structured surveys that access the clarity of the explanation, the alignment with human expectations, and the overall interoperability.

$$ε = \{ \begin{matrix}0 , & if explainability is inactive , \\ \hat{ε} ∈ ( 0 , 1 \vert , & ifexplainability is active\end{matrix}$$

where, \hat{ε} is a normalized score derived from survey response and subjective evaluation metrics.

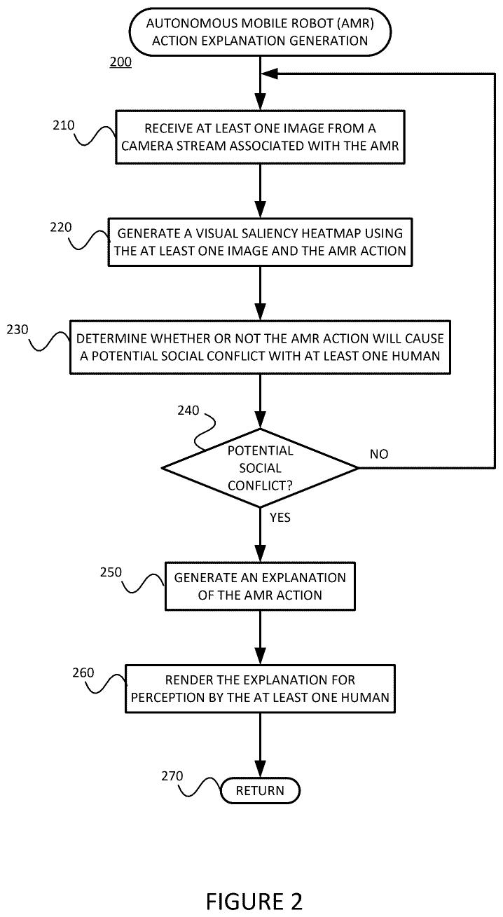

FIG. 2 is a flow diagram of an example method 200 for generating an (e.g., human perceivable and understandable) explanation of an AMR action. The example method 200 receives at least one image from a camera stream associated with the AMR. (Block 210) The example method 200 then generates a visual saliency heatmap using the at least one image and the AMR action. (Block 220) Next, the example method 200 determines whether or not the AMR action will cause a potential social conflict with at least one human. (Block 230) Responsive to determining that the AMR action will cause a potential social conflict with at least one human (Decision 240=YES), the example method 200 generates an explanation of the AMR action (Block 250) and causes the AMR to render the explanation for perception by the at least one human (Block 260). The example method 210 is then left. (Node 270) Referring back to decision 240, responsive to a determining that the AMR action will not cause a potential social conflict with at least one human (240=NO), the example method 200 branches back to block 210.

Referring back to block 250, in at least some example implementations of the method 200, the explanation includes the visual saliency heatmap. In at least some example implementations of the method 200, the method extracts features from the at least one image received, and generates a natural language explanation from at least one of (i) the features extracted, and/or (ii) the visual saliency heatmap, wherein the explanation includes both (i) the visual saliency heatmap and (ii) the natural language explanation. In some such implementations, the natural language explanation is generated from at least one of (i) the features extracted, and/or (ii) the visual saliency heatmap, by (1) generating from the features extracted, a caption using a vision language model (VLM), and (2) generating the natural language explanation from the caption and the visual saliency heatmap. Referring back to block 260, in at least some such implementations, the act of rendering the explanation for perception by at least one human includes displaying both (1) the visual saliency heatmap and (2) the natural language explanation. In at least some other such implementations, the act of rendering the explanation for perception by at least one human includes (1) displaying the visual saliency heatmap, (2) synthesizing speech from the natural language explanation, and (3) outputting, via a speaker, the speech synthesized. The caption may be a contextual caption describing the AMR action in the context of the at least one image. As discussed in more detail below, the caption may be generated using Bootstrapped Language Image Pretraining (BLIP). In some example implementations, the visual saliency heatmap is generated using a Gradient-weighted Class Activation Mapping with a Residual Network neural network model to highlight image areas that contributed most to the AMR action. In some example implementations, the act of generating a natural language expression is performed by a large language model (LLM) external to the AMR.

Referring back to block 230, in at least some example implementations of the example method 200, the act of determining whether or not a potential social conflict exists includes determining whether or not the AMR action is more probable than a predetermined threshold to cause human discomfort. The threshold may be changed so that it is a function of the urgency of the AMR action. In some example implementations, the potential social conflict is one or more of (A) a potential discomfort caused to the at least one human by the AMR action, (B) a potential discomfort caused to the at least one human by an alternative to the AMR action, (C) determining that at least one human will be within a predetermined distance of a planned path of the AMR, (D) determining that at least one human will be within a predetermined distance of a planned path of the AMR and have a line of sight of the AMR in the planned path, (E) determining that at least one human will be able to hear the AMR as it navigates a planned path, and/or (F) determining that at least one human will have an activity interrupted by a planned path of the AMR. Note that a “social conflict” may depend on cultural norms, which may be implied by location information of the AMR (or other information gathered by, or provided to, the AMR).

Referring back to blocks 250 and 260, in some example implementations, the explanation of the AMR action is a proposed path of the AMR, and the act of rendering the explanation for perception by at least one human includes projecting the proposed path of the AMR.

In some example implementations, a utility of the explanation is a function of both (1) a latency needed to generate the explanation, and (2) content of the explanation. In such example implementations, the act of generating the explanation of the AMR action includes increasing or maximizing the utility of the explanation.

### § 5.4.2 Example Explainability Model Architecture

In one example architecture, the robot is equipped with a modular explainability model implemented as four ROS2 nodes, namely: (1) Camera Node; (2) BLIP Node; (3) Heatmap Node, and (4) LLM node. Each of these nodes will be described in more detail below. Under this example architecture, each node is responsible for a distinct function. These nodes communicate through ROS “topics,” thereby enabling scalable and seamless integration with existing navigation systems. These nodes cooperate to present information in a concise, human-understandable format, enhancing explainability in dynamic environments. The camera node captures a single image on request. In this example architecture, the LLM node is initialized first, followed by the Heatmap node and the BLIP node.

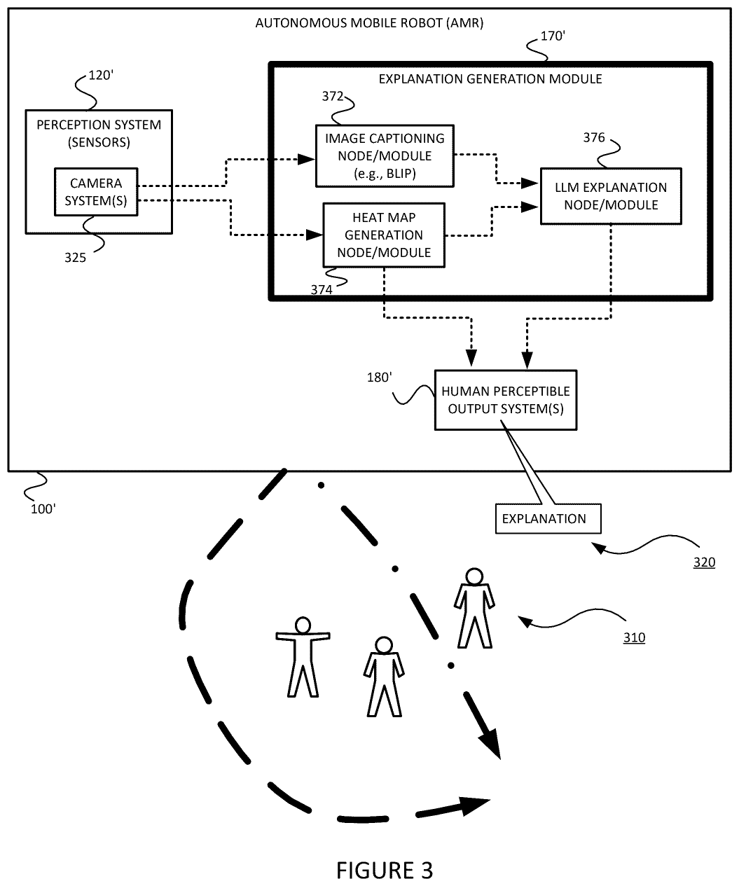

FIG. 3 illustrates an example AMR 100′ provided with this type of architecture, and an example of the operations of its components. As shown, the AMR 100′ includes, among other components, a perception system 120′, an explanation generation module/node 170′, and human perceptible output system(s) 180′. As shown, the perception system 120′ includes camera system(s) 325. In this example, the camera system(s) 325 includes a video camera. The explanation generation module/node 170′ includes an image captioning node/module 372, a heatmap generation node/module 374 and a large language model (LLM) node/module 376. Although not shown, the human perceptible output system(s) 180′ include one or more of a projector, a display screen, and/or a speaker.

The explanation generation module/node 170′ interprets a scene relevant to the AMR or its action (or intended action) and communicates its intended action and/or the reasoning for its intended action to one or more humans 310. To do this, the camera system(s) 325 captures at least one image of the relevant scene using an onboard video camera. The image captioning node/module 372 generates a scene description of a captured image(s) using, for example, vision language models. The heatmap generation node/module 374 generates a heatmap and summary of the captured image(s). The LLM explanation node/module 376 generates a summary of the scene in the captured images using large language models. The human perceptible output system(s) 380 generate an explanation 320 that may include at least one of (A) a display or projection of the heatmap output from the heatmap generation node/module 374, (B) a display or projection of the summary of the scene output from the LLM explanation node/module 376, and/or (C) an audio output for speech synthesized from the summary of the scene output from the LLM explanation node/module 376, etc. Alternatively, or in addition, the explanation 320 may include output derived from any of the foregoing.

As one example, suppose that the shortest path for the AMR 100′ is along the dot-dashed line. Since, however, this path might disrupt a conversion among the people 310, it navigates along the dashed line path, around the group of people 310. It may, nonetheless, explain to the people 310 (via explanation 320) that “I am walking around you to get to ______.” Consider, however, an emergency scenario in which the AMR must get to its destination as quickly as possible. In such a scenario, the AMR might take the dot-dashed line path between the people 310. Assume that this scenario will cause a social conflict. In such a scenario, the AMR may explain to the people 310 (via explanation 320), “Please excuse me. I have to get to ______ to assist in an emergency.”

Pseudocode for an explainability module 170″ via VLM 372, Heatmap 374 and LLM 376 nodes is provided here:

| | |
|---|---|
| 1 | Initialize LLM Node and Explainability Module; |
| 2 | Subscribe to topics ’camera/image’, ’blip/caption’, and ’heatmap/summary’; |
| 3 | Set explainability factor ε ← 0; |
| 4 | Set ExplainabilityModuleEnabled flag; |
| | while robot is navigating do |
| 5 | Receive image from camera stream; |
| 6 | Detect potential social conflict using VLM Node; |
| 7 | Generate visual saliency map using Heatmap Node; |
| | if conflict is detected then |
| | if ExplainabilityModuleEnabled then |
| 8 | Generate natural language explanation using LLM Node; |
| 9 | Synthesize and output speech from explanation; |
| 10 | Overlay and display heatmap with textual explanation; |
| 11 | Save image, heatmap, and explanation with timestamp; |
| 12 | Update explainability factor ε ← ε + Δε; |
| | end |
| 13 | Update navigation path to avoid conflict; |
| | end |
| 14 | Execute current navigation step; |

end

| | |
|---|---|
| 15 | Analyze navigation performance metrics (e.g., path efficiency, social acceptance); |
| 16 | Correlate performance with explainability factor ε. |

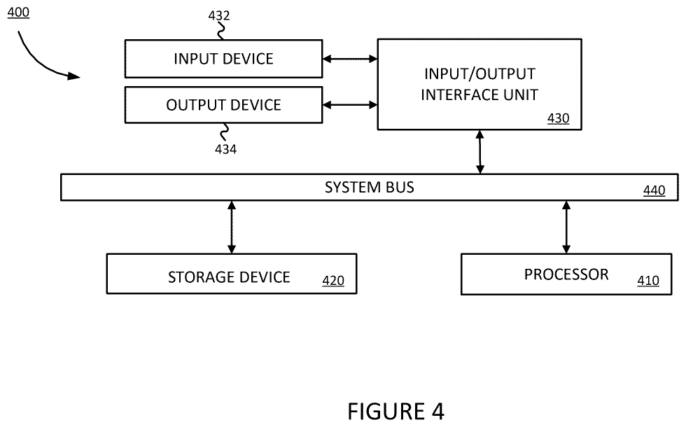

Referring back to FIG. 1, the controller/control system 110, and/or the explanation generation module 170 may be implemented on an example system 400 as illustrated on FIG. 4.

FIG. 4 is a block diagram of an exemplary machine 400 that may perform one or more of the processes described, and/or store information used and/or generated by such processes. The exemplary machine 400 includes one or more processors 410, one or more input/output interface units 430, one or more storage devices 420, and one or more system buses and/or networks 440 for facilitating the communication of information among the coupled elements. One or more input devices 432 and one or more output devices 434 may be coupled with the one or more input/output interfaces 430. The one or more processors 410 may execute machine-executable instructions (e.g., C or C++ running on the Linux operating system widely available from a number of vendors) to effect one or more aspects of the present description. At least a portion of the machine executable instructions may be stored (temporarily or more permanently) on the one or more storage devices 420 and/or may be received from an external source via one or more input interface units 430. The machine executable instructions may be stored as various software modules, each module performing one or more operations. Functional software modules are examples of components of the present description.

In some embodiments consistent with the present description, the processors 410 may be one or more microprocessors and/or ASICs. The bus 440 may include a system bus. The storage devices 420 may include system memory, such as read only memory (ROM) and/or random access memory (RAM). The storage devices 420 may also include a hard disk drive for reading from and writing to a hard disk, a magnetic disk drive for reading from or writing to a (e.g., removable) magnetic disk, an optical disk drive for reading from or writing to a removable (magneto-) optical disk such as a compact disk or other (magneto-) optical media, or solid-state non-volatile storage.

Some example embodiments consistent with the present description may also be provided as a machine-readable medium for storing the machine-executable instructions. The machine-readable medium may be non-transitory and may include, but is not limited to, flash memory, optical disks, CD-ROMs, DVD ROMs, RAMs, EPROMs, EEPROMs, magnetic or optical cards or any other type of machine-readable media suitable for storing electronic instructions. For example, example embodiments consistent with the present description may be downloaded as a computer program which may be transferred from a remote computer (e.g., a server) to a requesting computer (e.g., a client) by way of a communication link (e.g., a modem or network connection) and stored on a non-transitory storage medium. The machine-readable medium may also be referred to as a processor-readable medium.

Example embodiments consistent with the present description (or components or modules thereof) might be implemented in hardware, such as one or more field programmable gate arrays (“FPGA”s), one or more integrated circuits such as ASICs, one or more network processors, etc. Alternatively, or in addition, embodiments consistent with the present description (or components or modules thereof) might be implemented as stored program instructions executed by a processor.

### 5.4.2.1 Example Node Details

Details of example system(s)/nodes/modules such as those in the explanation generation module 170′ of FIG. 3 (e.g., camera node, BLIP node, heatmap node, and LLM node) used in an example ROS explainability architecture are now described.

As the camera system(s) 325, an example camera node captures images on demand, saving and publishing them to /camera/imageRaw for processing. This ensures optimized computational resources while providing the necessary visual input for the explainability module. As the image captioning node/module 372, an example BLIP node processes images using Boot-strapped Language Image Pretraining (BLIP) to generate a contextual caption describing the image content. It subscribes to the /camera/imageRaw topic to retrieve images and runs the BLIP model using the Hugging Face API due to its high computational requirements. The generated caption is published on the /blip/caption topic, where other nodes can access it. This step bridges the gap between raw visual input and human-readable descriptions. Algorithm 2 shows the pseudocode of the node working process.

### Algorithm 2: BLIP Node Image Captioning

| 1 | Initialize the BLIP Node; |
|---|---|
| 2 | Subscribe to topic ’camera/image raw’; |
| while new image received do | |
| 3 | Extract features from image; |
| 4 | Generate caption using VLM; |
| 5 | Publish caption to topic ’blip/caption’; |
| 6 | if publish successful then |

Log success
end else
Log failure
end end

As the heatmap generation node/module, an example heatmap node visualizes the most relevant regions of the image that influenced the captioning of the BLIP model. It applies Grad-CAM (Gradient-weighted Class Activation Mapping) with a ResNet model to highlight image areas that contribute the most to the BLIP output. In addition to generating the heatmap overlay, the node calculates the percentage of the image that the model focuses on and publishes this as a concise summary of the /heatmap/summary topic. This provides quantitative insights into the influence of different image regions, enhancing transparency in decision-making. Algorithm 3 shows the pseudocode of the node's working process.

### Algorithm 3: Heatmap Node Processing

| 1 | Initialize the Heatmap Node; |
|---|---|
| 2 | Subscribe to topic ’camera/image raw’; |
| while new image received do | |
| 3 | Process image to generate heatmap overlay; |
| 4 | Save heatmap image; |
| 5 | Publish heatmap summary to topic |
| ’heatmap/summary’; | |
| 6 | if publish successful then |

Log success
end else
Log failure
end end

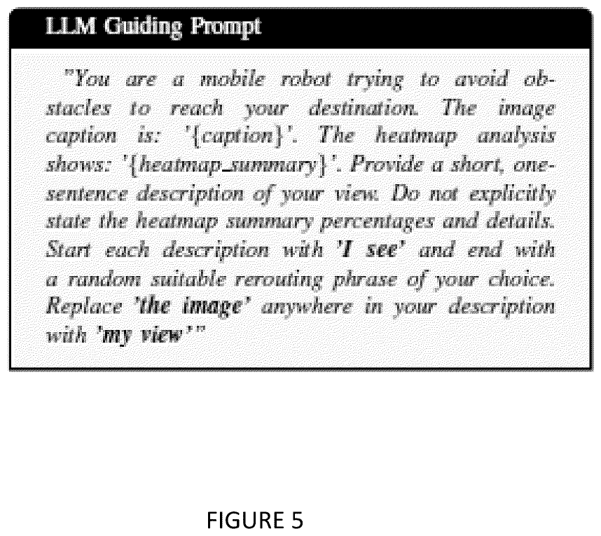

As the LLM explanation node/module, an example LLM Node generates a natural language explanation of the robot's surroundings and decision making rationale. It subscribes to both /blip/caption and /heatmap/summary, merging these outputs to form a coherent, structured response. A guiding prompt (See, e.g., FIG. 5) is used to ensure that the explanation follows a consistent and understandable format. Due to the high computational demands of GPT-3.5 Turbo, the processing is offloaded to the Azure OpenAI API, ensuring efficient real-time response generation. Algorithm 4 shows the pseudocode of the node's working process.

### Algorithm 4: LLM Node Explanation Generation

| 1 | Initialize the LLM Node; |
|---|---|
| 2 | Subscribe to topics ’blip/caption’ and |
| ’heatmap/summary’; | |
| while caption and heatmap summary received do | |
| 3 | Generate textual explanation using LLM; |
| 4 | Synthesize speech output from the generated explanation; |
| 5 | Display and save explanation with heatmap overlay; |
| 6 | Save image and heatmap with timestamp for validation; |
| 7 | if processing successful then |

Log success
end else
Log failure
end
end

### § 5.5 REFINEMENTS, ALTERNATIVES, AND EXTENSIONS

Although at least some of the example embodiments described above concerned interactions between an autonomous robot and one or more humans, the example embodiments can be extended to interactions and/or communications between an autonomous robot and one or more other robots.

Details of an example methodology are now provided.

### § 5.5.1 Explainability Model Formulation

To formally define our explainability model, let X represent the raw image input captured by the robot's camera. The explainability function E maps the visual input, the heatmap analysis, and the language model output to a structured explanation by:

$$E : ( X , H , L ) \to T \qquad ( 7 )$$

where, X∈ [symbol] ^{m×n×3} is the image captured at resolution m×n, H=g(X) is the heatmap function that highlights the salient regions, L=f(X, H) represents the captioning output of the language model and T is the final textual explanation produced. The heatmap generation function g(X) is given by Grad-CAM activation A_{c} as

$${H}_{i , j} = ReLU ( {\sum }_{k} {α}_{k} {A}_{c}^{i , j} ) \qquad ( 8 )$$

where αₖ is the weight for the feature map k, A_{c}^{i,j} represents the activation at the spatial location (i,j) and ReLU(⋅) ensures positive activation contributions. The final natural language T is derived using

$$T = L L M ( ψ ( H , X ) ) \qquad ( 9 )$$

where, ψ(H, X) is the feature representation that combines the heatmap and the image context and LLM (⋅) is a large language model (e.g., GPT-3.5 Turbo) trained for textual summarization obtained in the LLM Guidance Prompt box. The textual explanation generated by the LLM, which depends on the human context and perception input and the variables related to the robot interface, captured as uncertainty U, which reflects subjective interpretation, clarity of the interface and variability of trust.

$$ε = f ( T , U ) . \qquad ( 10 )$$

User surveys will allow determining ε more precisely.

### § 5.5.2 Latency Optimization for Real-Time Explainability

Latency is critical in real-time systems. The total explanation time Tₜₒₜₐₗ is defined as:

$${T}_{total} = {T}_{camera} + {T}_{BLIP} + {T}_{heatmap} + {T}_{LLM} \qquad ( 11 )$$

where, T_{camera} is the image acquisition time, T_{BLIP} is the processing time in the vision language, Tₕₑₐₜₘₐₚ is the heatmap generation time, and T_{LLM} is the time required for the large language model to generate an explanation. Since LLM processing is performed remotely, LLM request latency T_{LLM} can be modeled as

$${T}_{LLM} = {T}_{network} + {T}_{processing} \qquad ( 12 )$$

where, T_{network} represents the latency of network transmission and T_{processing} is the cloud-based inference time. To minimize Tₜₒₜₐₗ, one can formulate the optimization problem as

$$min λ {\sum }_{i} {T}_{i} , s . t . {T}_{total} \leq {T}_{max} \qquad ( 13 )$$

where, λ represents hyperparameters tuning latency tradeoffs and Tₘₐₓ is the maximum allowable latency for real-time operation.

Empirical analysis showed that latency is inversely correlated with compute power C:

$${T}_{total} ∝ \frac{1}{C} \qquad ( 14 )$$

where increasing computing power reduces processing time.

### § 5.6 EXAMPLES OF HANDLING DIFFERENT SCENARIOS

In the following, various examples showing what to look for (e.g., in BLIP/LLM or heatmap) and example human perceptive outputs for different categories of scenarios are provided, for purposes of illustration. The examples provided are not exhaustive. As a first example, assume a scenario in which the AMR senses that a person is lying down or collapsed (category=human posture). The AMR looks for a “person lying”, “laying”, “collapsed”, “unconscious”, “sleeping on floor”, etc. and outputs “Person down detected. Should I alert security? If yes, say “YES”, if not, say “NO”. If there is no response in 10 seconds, I will alert security automatically.” So the AMR is providing people in the area with an explanation of an intended action (alert security) and the reason for the action (person down detected).

As a second example, assume a scenario in which the AMR senses fire or smoke (category=hazard). The AMR looks for a “fire”, “smoke”, “burning”, “flame”, etc. and outputs “Fire detected. Alerting emergency services.” So the AMR is providing people in the area with an explanation of an intended action (alerting emergency services) and the reason for the action (fire detected).

As a third example, assume a scenario in which the AMR senses a knife, gun, or suspicious item (category=weapon). The AMR looks for a “knife”, “gun”, “weapon”, “sharp object”, etc. and outputs “Weapon detected. Locking area and notifying security.” So the AMR is providing people in the area with an explanation of intended actions (locking area and notifying security) and the reason for the action (weapon detected).

As a fourth example, assume a scenario in which the AMR senses a crowd forming, or a fight (category=crowd/conflict). The AMR looks for a “people fighting”, “large crowd”, “confrontation”, etc. and outputs “Conflict detected. Please disperse. Alerting security.” So the AMR is providing people in the area with an explanation of an intended action (alerting security) and the reason for the action (conflict detected).

As a fifth example, assume a scenario in which the AMR senses a blocked pathway (category=obstruction). The AMR looks for a “blocked path”, “obstacle”, “barrier”, “hole”, “stop”, “closed”, etc. and outputs “Obstruction ahead. Adjusting my path.” So the AMR is providing people in the area with an explanation of an intended action (adjusting my path) and the reason for the action (obstruction).

As a sixth example, assume a scenario in which the AMR senses trash or a spill (category=cleanliness). The AMR looks for a “garbage”, “spill”, “messy floor”, “wet area”, etc. and outputs “Cleaning alert. Trash detected in hallway. I will alert maintenance.” So the AMR is providing people in the area with an explanation of an intended action (alerting maintenance) and the reason for the action (trash detected in hallway).

As a final example, assume a scenario in which the AMR senses broken furniture or holes in the ground (category=safety). The AMR looks for a “broken chair”, “hole in ground”, “cracked floor”, “cracked”, etc. and outputs “Hazardous condition detected. Marking area for review.” So the AMR is providing people in the area with an explanation of an intended action (marking area for review) and the reason for the action (hazardous condition detected.

### § 5.7 EXPERIMENTAL RESULTS

To validate the effectiveness of our explainability module, the present inventors conducted structured experiments using robot running ROS 1 Noetic on a Raspberry Pi 4B with a built-in camera. The system was tested in both manual and autonomous navigation modes, with and without the explainability module active.

### § 5.7.1 Experimental Setup

The explainability module, originally developed in ROS 2 Humble, was adapted to ROS 2 Foxy and deployed on a separate system for compatibility with the MYAGV robot. Communicated independently while generating real-time explanations. The robot was equipped with a speaker and display to provide multimodal feedback. The images were captured every 5 seconds and processed by the Camera, BLIP, Heatmap, and LLM nodes. Explanations were visualized as heatmap overlays and spoken aloud to enhance interpretability.

### § 5.7.2 Navigation and Testing Conditions

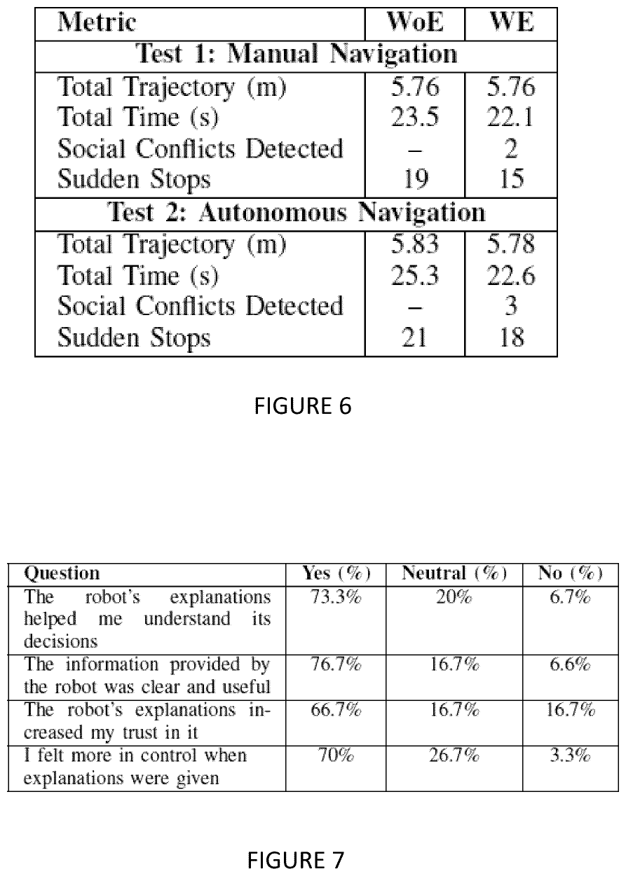

The experiments were carried out under four scenarios:
Manual Navigation: As Test 1—With and without explainability.
Autonomous Navigation: As Test 2—With and without explainability.
   For each test, the present inventors recorded navigation metrics and explanation output, allowing us to isolate the impact of explainability as represented in table of FIG. 6. This table provides a comparison of navigation performance under two conditions: woe=without explainability, we=with explainability. Tests were conducted over a 14-meter delivery task (average of 4 runs in hallway and maker-space). Metrics include total trajectory length, time taken, number of social conflict detections, and sudden stops.

### § 5.7.3 User Survey

During each test, the participants observed the robot and completed a post-run survey assessing trust, clarity, and transparency. These responses were used to calculate a normalized explainability factor ε∈[0, 1], with ε=0 for non-explaining runs. The present inventors collect responses from 30 participants, including students and faculty.

### § 5.7.4 Analysis of Experimental Results

The present inventors analyze the AMR performance metrics along with ε to assess how explainability influenced navigation behavior. This included latency, stability, and confusion matrix evaluations comparing system output with human expectations. The Table of FIG. 7 (survey results measuring user trust) summarizes the responses to Test 2, showing a significant increase in user trust and understanding when explanations were provided. The present inventors computed the overall preference score using the following.

$$PS = \frac{U + 0.5 N}{T} \times 100 , \qquad ( 15 )$$

where, U=22 (users who prefer explanations), N=6 (neutral responses), and T=30 (total participants), resulting in a PS of 76.7%. FIGS. 3 and 4 (Test 1 and Test 2, respectively) highlight a notable improvement in trust (+16.7%), understanding (+23.3%) and overall preference (from 50% to 76.7%) when explanations were enabled.

### § 5.7.4.1 Explanation Latency Analysis

The latency from module initialization to LLM summary display was measured in 88 samples, ranging from 5.986 to 50.688 seconds, with an average of approximately 20 seconds. Manual triggering significantly reduced high-latency occurrences compared to fixed 25-second intervals. The system, running on a Raspberry Pi 4 Model B (quad-core Cortex-A72, 4 GB RAM), demonstrates that hardware limitations contribute to processing delays, suggesting that future upgrades may yield sub-5 second latency. Higher latency directly impacts the explainability factor ε, as delayed explanations reduce user trust, perceived system responsiveness, and transparency. In real-time navigation, if the robot's explanation arrives too late relative to its decision, users may find the behavior confusing or untrustworthy. Thus, minimizing latency is critical to maintaining high ε scores in user evaluation.

### § 5.7.4.2 Response Consistency via Confusion Matrix

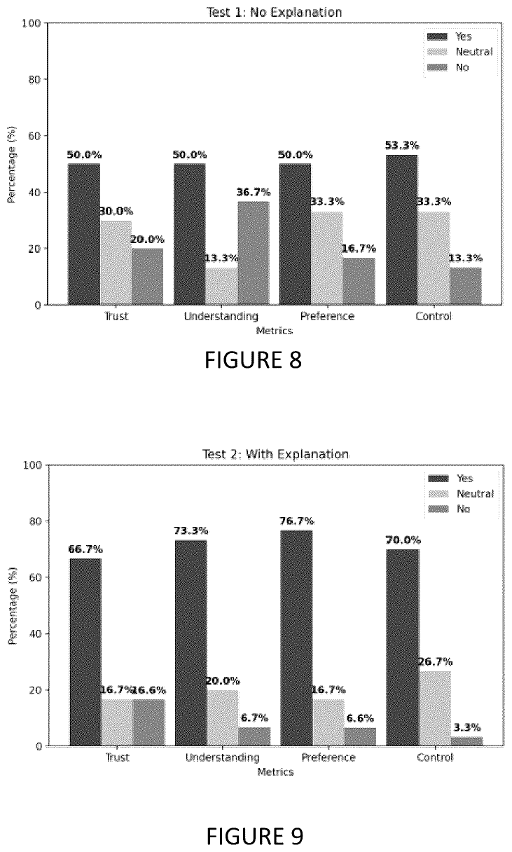

The present inventors evaluated the precision of the explanation by comparing the model output with ground truth labels. Table III of FIG. 8 shows the confusion matrix with 196 evaluated images (TP=82, FN=15, FP=20, TN=79). Performance metrics were computed as follows.

$$Accuracy = \frac{TP + TN}{TP + FP + FN + TN} = 82.14 \% \qquad ( 16 )$$

FIG. 8 is a bar chart of user survey results under Test 1. FIG. 9 is a bar chart of user survey results under Test 2.

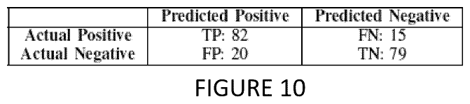

Finally, the table in FIG. 10 is a confusion matrix showing performance of the explainability module for true positive (tp), false positive (fp), false negative (fn), and true negative (tn).

### § 5.8 CONCLUSIONS

This study demonstrates that the integration of social context awareness using visual and language models as explainability module into mobile robot navigation significantly improves performance and social acceptance in collaborative environments between humans and robots. The survey results and experimental evaluations confirm that real-time explanations improve trust, interpretability, and transparency by aligning robot behavior with human expectations and reducing uncertainty. The high accuracy of the system and the F1 score further validate its effectiveness in addressing the black-box limitations of AI. Although latency remains a challenge, results show that optimized explanation delivery contributes to more predictable and user-aligned robotic actions.

What is claimed is:

1. A computer-implemented method for generating a human-interpretable/comprehensible explanation of an autonomous mobile robot (AMR) action, the computer-implemented method comprising:
a) receiving at least one image from a camera stream associated with the AMR;
b) generating a visual saliency heatmap using the at least one image and the AMR action;
c) determining whether or not the AMR action will cause a potential social conflict with at least one human;
d) responsive to determining that the AMR action will cause a potential social conflict with at least one human, generating an explanation of the AMR action; and
e) rendering the explanation for perception by the at least one human.

2. The computer-implemented method of claim 1, wherein the explanation includes the visual saliency heatmap.

3. The computer-implemented method of claim 1, further comprising:
extracting features from the at least one image received;
generating a natural language explanation from at least one of (i) the features extracted, and/or (ii) the visual saliency heatmap,
wherein the explanation includes both (i) the visual saliency heatmap and (ii) the natural language explanation.

4. The computer-implemented method of claim 3, wherein the natural language explanation is generated from at least one of (i) the features extracted, and/or (ii) the visual saliency heatmap, by
generating from the features extracted, a caption using a vision language model (VLM); and
generating the natural language explanation from the caption and the visual saliency heatmap.

5. The computer-implemented method of claim 4, wherein the act of rendering the explanation for perception by at least one human includes displaying both (1) the visual saliency heatmap and (2) the natural language explanation.

6. The computer-implemented method of claim 4, wherein the act of rendering the explanation for perception by at least one human includes (1) displaying the visual saliency heatmap, (2) synthesizing speech from the natural language explanation, and (3) outputting, via a speaker, the speech synthesized.

7. The computer-implemented method of claim 4, wherein the caption is a contextual caption describing the AMR action in the context of the at least one image.

8. The computer-implemented method of claim 7, wherein the caption is generated using Bootstrapped Language Image Pretraining (BLIP).

9. The computer-implemented method of claim 4, wherein the visual saliency heatmap is generated using a Gradient-weighted Class Activation Mapping with a Residual Network neural network model to highlight image areas that contributed most to the AMR action.

10. The computer-implemented method of claim 3, wherein the act of generating a natural language expression is performed by a large language model (LLM) external to the AMR.

11. The computer-implemented method of claim 1, wherein the act of determining whether or not a potential social conflict exists includes determining whether or not the AMR action is more probable than a predetermined threshold to cause human discomfort.

12. The computer-implemented method of claim 1, wherein the explanation of the AMR action is a proposed path of the AMR, and
wherein the act of rendering the explanation for perception by at least one human includes projecting the proposed path of the AMR.

13. The computer-implemented method of claim 1, wherein the potential social conflict is a potential discomfort caused to the at least one human by the AMR action.

14. The computer-implemented method of claim 1, wherein the potential social conflict is a potential discomfort caused to the at least one human by an alternative to the AMR action.

15. The computer-implemented method of claim 1, wherein the act of determining whether or not the AMR action will cause a potential social conflict with at least one human includes determining whether or not at least one human will be within a predetermined distance of a planned path of the AMR.

16. The computer-implemented method of claim 1, wherein the act of determining whether or not the AMR action will cause a potential social conflict with at least one human includes determining whether or not at least one human will be within a predetermined distance of a planned path of the AMR and have a line-of-sight of the AMR in the planned path.

17. The computer-implemented method of claim 1, wherein the act of determining whether or not the AMR action will cause a potential social conflict with at least one human includes determining whether or not at least one human will be able to hear the AMR as it navigates a planned path.

18. The computer-implemented method of claim 1, wherein the act of determining whether or not the AMR action will cause a potential social conflict with at least one human includes determining whether or not at least one human will have an activity interrupted by a planned path of the AMR.

19. The computer-implemented method of claim 1, wherein a utility of the explanation is a function of both (1) a latency needed to generate the explanation, and (2) content of the explanation, and
wherein the act of generating the explanation of the AMR action includes increasing or maximizing the utility of the explanation.

20. An autonomous mobile robot (AMR) comprising:
a) a video camera;
b) at least one processor for generating an explanation of an action of the AMR; and
c) a computer-readable storage medium storing instructions, which when executed by the at least one processor, cause the at least one processor to perform a method including
1) receiving at least one image from the video camera;
2) generating a visual saliency heatmap using the at least one image and the action of the AMR;
3) determining whether or not the action of the AMR will cause a potential social conflict with at least one human;
4) responsive to determining that the action of the AMR will cause a potential social conflict with at least one human, generating the explanation of the action of the AMR; and
d) a human perceptible output system configured to render the explanation for perception by the at least one human.
